(19) United States
(12) Patent Application Publication
(10) Pub. No.: US 2015/0262264 A1
(43) Pub. Date: Sep. 17, 2015

(54) CONFIDENCE IN ONLINE REVIEWS

(71) Applicant: INTERNATIONAL BUSINESS MACHINES CORPORATION, Armonk, NY (US)

(72) Inventors: ANA PAULA APPEL, SAO PAULO (BR); VICTOR FERNANDES CAVALCANTE, JD. MADALENA (BR); VAGNER FIGUEREDO DE SANTANA, SAO PAULO (BR)

(73) Assignee: INTERNATIONAL BUSINESS MACHINES CORPORATION, Armonk, NY (US)

(21) Appl. No.: 14/205,860

(22) Filed: Mar. 12, 2014

(51) Int. Cl. G06Q 30/02; G06F 17/30; G06Q 50/00

(52) U.S. Cl. CPC G06Q 30/0282; G06Q 50/01; G06F 17/30864

(57) ABSTRACT

A method for ranking online reviews includes: performing an internet search on a search term provided by a user to find online reviews, determining users that wrote the online reviews (i.e., reviewers), performing an internet search for the reviewers to find online reviews by the reviewers, determining characteristics from all the found online reviews that are most relevant to the user, presenting the determined characteristics to the user for applying weights to each characteristic, and ranking the online reviews based on the applied weights.

### BACKGROUND

1. Technical Field

The present disclosure relates to online reviews, and more particular to improving confidence in online reviews.

2. Discussion of Related Art

An increasing amount of offers and advertisements for products and services are found on the Internet. A potential buyer may use a variety of available sources to obtain more precise information about a given product/service to increase confidence in the product/service before making the corresponding purchase. These sources may include various electronic data such as on-line individual reviews.

A search on the Internet for a product can produce thousands of these reviews. For example, an offer for a product displayed on the AMAZON website displays a count of the number of user reviews for that product, a favorability rating (e.g., 4/5 stars) that indicates overall how favorable these users consider the product to be, and a selectable link that allows a user to read the reviews. However, if some of the reviews are erroneous (e.g., misleading, biased, fake, etc.), the favorability rating can be misleading. Further, while a user can attempt to read the reviews to gain confidence in their authenticity, it can be difficult to determine which reviews are erroneous and which are valid.

Accordingly, there is a need for methods and systems that can improve confidence in online reviews.

### BRIEF SUMMARY

According to an exemplary embodiment of the invention, a method for ranking online reviews includes: performing an internet search on a search term provided by a user to find online reviews of a corresponding product or service, determining users that wrote the online reviews (i.e., reviewers), performing an internet search for the reviewers to find online reviews by the reviewers, determining characteristics from all the found online reviews that are most relevant to the user, presenting the determined characteristics to the user for applying weights to each characteristic, and ranking the online reviews of the corresponding product or service based on the applied weights.

According to an exemplary embodiment of the invention, a method for presenting online reviews includes: performing an internet search to find online reviews for a given product or service, determining identities of reviewers, performing an internet search for additional reviews by the reviewers, determining a confidence score of each reviewer based on their reviews, and presenting only the reviews having a confidence score higher than a pre-defined threshold.

### BRIEF DESCRIPTION OF THE SEVERAL VIEWS OF THE DRAWINGS

Exemplary embodiments of the invention can be understood in more detail from the following descriptions taken in conjunction with the accompanying drawings in which:

FIG. 1 illustrates a system that can provide ranked online reviews according to an exemplary embodiment of the invention.

FIG. 2 illustrates a method to perform a search for a product or service according to an exemplary embodiment of the invention.

FIG. 3 is an example of characteristics that could be presented to a user for weighting.

FIG. 4 illustrates reviews being ranked according to an exemplary embodiment of the invention.

FIG. 5 illustrates a method of ranking online reviews according to an exemplary embodiment of the invention.

FIG. 6 illustrates a method of presenting online reviews according to an exemplary embodiment of the invention.

FIG. 7 illustrates an example of a computer system capable of implementing methods and systems according to embodiments of the disclosure.

### DETAILED DESCRIPTION

Embodiments of the present invention relates to methods and/or systems to evaluate and improve confidence in online reviews.

At least one embodiment of the invention performs an evaluation of online reviews that takes into account many complimentary data sources that can help to guide the consumer decision about the potential acquisition of a new product or service. In an exemplary embodiment, the evaluation produces an index (indicator) that can reinforce (or not) the credibility of a given review, which can diminish uncertainty related to the acquisition, and consequently mitigate consumer frustration and/or disappointment. In an exemplary embodiment, the evaluation considers relevant electronic available about potential buyers, the reviewers, and the offer itself.

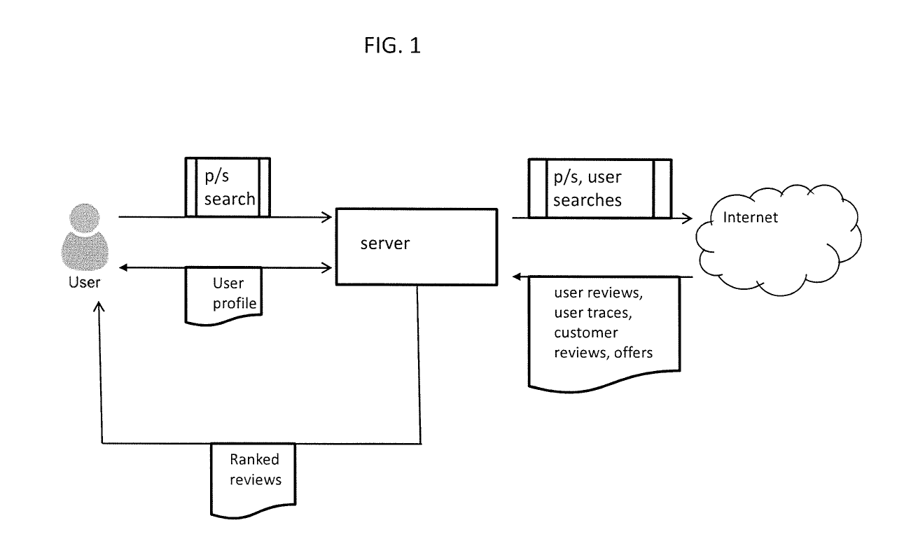

FIG. 1 illustrates a system that can provide ranked online reviews according to an exemplary embodiment of the invention. A user that wants to look for offers logs into the server. The server may be any type of computer. The user may logon to the server by running a client program on a user computer (e.g., a desktop computer, tablet computer, smartphone, etc.) that interfaces with a server program of the server. The user computer and the server may be locally connected or remotely connected to one another across a network (e.g., a local area network connected to the Internet).

If this is the first time that the user has logged onto the server, the server sends a form to the user that enables the user to create a user profile that is stored on the server. The server can send the form to the user by formatting a computer message including details about the form to the client program of the user. The client program can then present a graphical user interface with the form to the user.

The form may include general questions or the questions may be tailored based on what the user is currently searching for or has previously searched for. For example, if the user is currently searching for a room in a hotel, the form could ask them their preferences such as whether they need/prefer “a large bathroom”, “a non-smoking room”, “hardwood floors”, “air conditioning”, “a kitchen”, etc. In another example, if the user is currently searching for a certain type of electronic device new, the form could ask them whether they need/prefer a particular brand, a certain power rating, a certain price range, etc. The above searches and questions are merely examples as the invention is not limited to searching for any particular service or product and the form is not limited to any particular question.

The form may also inquire about what identifiers the user uses when posting on the internet or posting online reviews, what social networks they post on, what websites they frequent, etc.

The user can also update the user profile on subsequent logins. In an exemplary embodiment, the form enables the user to select a product type, and then the questions asked are tailored to towards that product type. The selected product type can then be used to perform a subsequent search.

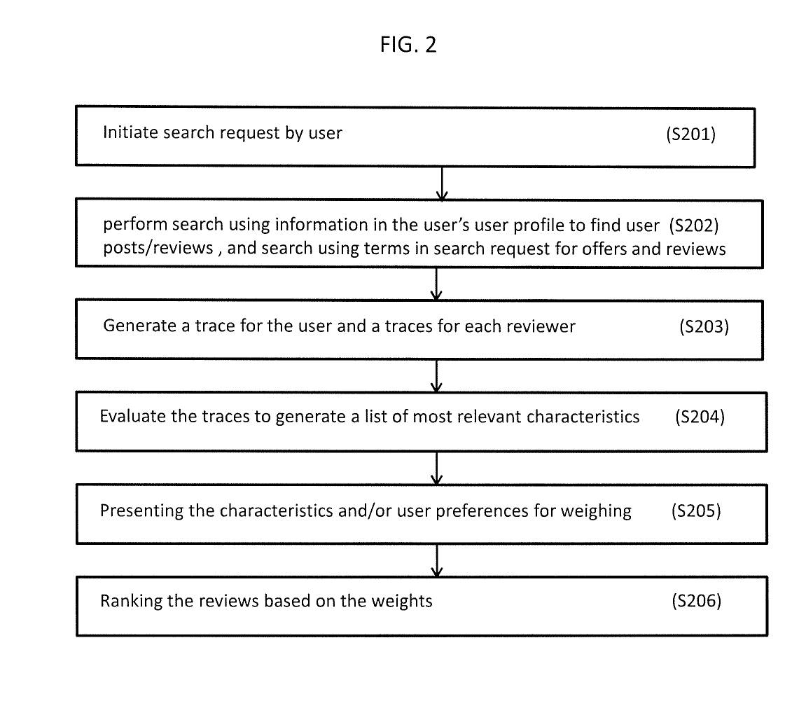

FIG. 2 illustrates a method to perform a search for a product or service according to an exemplary embodiment of the invention.

The method includes a user entering one or more search terms related to a product or service to initiate a search request (S201). The user can use the client program that interfaces with the server to enter the terms to initiate the search request. The client program can format a computer message that includes the terms and send the computer message including the search request to the server.

Upon receipt of the search request, the server performs a search of the Internet using the information stored within the user profile to find Internet posts (e.g., may include reviews) by the user and performs a search using the terms of the search request for offers and reviews (S202). For example, if the user indicated in their user profile they comment online using a particular name (or identifier), the server can search the internet for all posts using that name.

The above searching may be performed using one or more search engines (e.g., GOOGLE, YAHOO, BING, etc.) or by searching directly within vendor websites (e.g., AMAZON.COM, BESTBUY.COM, HOTELS.COM, EXPEDIA.COM, etc.).

For example, a search using terms such as “hotel in Rio de Janeiro” could result in offers such as a room in hotel A from EXPEDIA.COM with 10 reviews, a room in hotel A from HOTELS.COM with 5 reviews, etc.

The system then generates a trace for the user from the found user posts and generates traces for each reviewer from among the found customer reviews (S203). In an exemplary embodiment, a user trace includes the text of each post by the user, and possibly a timestamp of each post. Similarly, a reviewer trace may include the text of each post (e.g., including reviews) by the reviewer and possibly a timestamp. In an exemplary embodiment, a post that is older than a pre-defined time can be deleted from a given trace.

A reviewer trace can be generated by extracting all of the unique reviewer identifiers from among the reviews returned by the search. For example, a table of reviewer traces can be generated, where each entry of the table list one of the identifiers (e.g., the name/ID of the reviewer) and lists all of the reviews of that reviewer. The system then evaluates the trace of the user and the traces found for the reviewers to generate a list of most representative/relevant characteristics (S204). Like the user, each reviewer may have their own user profile. A characteristic may be any text that is found within a given trace or something that can be inferred from the traces.

The system can check whether the review written by the reviewer matches with what the reviewer specifies in his/her user profile and if the review is in some sort similar with other reviews made by him/her. For example, if the reviewer indicates they are a vegetarian in their user profile, and the review is about a steakhouse, a characteristic indicating that the reviewer is inconsistent can be inferred and extracted.

A reviewer can be very negative about some offers, but if the reviewer is always or mostly negative in his/her reviews, a characteristic indicating the reviewer is excessively negative can be inferred and extracted. For example, the reviewer may be biased against the products of a given company. Similarly, when a reviewer that is excessively positive (e.g., always gives 5/5 stars), a characteristic indicating the reviewer is excessively positive can be extracted. For example, the reviewer may be biased towards products of a given company.

Another type of characteristic that can be extracted relates to social networks (e.g., FACEBOOK, TWITTER, LINKEDIN, etc.) and how close the user is to a given reviewer. For example, the characteristic could indicate that the reviewer uses the same social network as the user, is a close friend (connected via short path) on the user's social network, is a far friend (connected via longer path) on the user's social network, or does not use the same social network as the user. For example, a review from a close friend on the user's social network may have more credibility that someone outside their social network.

Another type of characteristic that can be extracted is locality or geography. For example, if review is from a reviewer that lives in a particular country, city, or region, this information can be extracted as a characteristic. The locality information may appear as text (e.g., “France”, “NYC”, etc.) in one or more reviews listed in the trace of a reviewer.

The characteristics are extracted based on all reviewers of an offer. In an exemplary embodiment, if a specific characteristic appears in all or most of all reviews (e.g., above a certain threshold) it is not relevant. For example, if a majority of the reviews are talking about carpet, it is not an important feature since it is common. However, if one characteristic appears in a few reviews (e.g., in a minority of reviews) it is relevant since it is not common. For example, if only a few reviewers point out some features, such as air conditioning, it is a relevant feature.

The method further includes the system presenting the extracted characteristics and/or preferences from the user profile for weighing by the user (S205). For example, the server can send a message to the client program to present a form (e.g., window) to the user listing the characteristics. The user may use the form to apply a weight to one or more of the selected characteristics (e.g., using Likert scales).

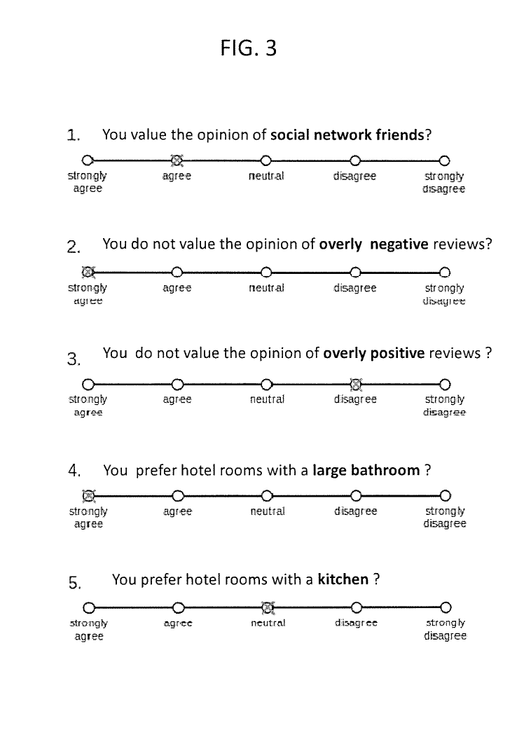

FIG. 3 is an example of a form that could be presented to a user to display the characteristics for applying weights. In this example, it is assumed that characteristics (see bolded text of FIG. 3) such as “social network friends”, “overly negative”, “overly positive”, “large bathroom”, and “kitchen” were considered to be the most relevant characteristics after the above described evaluation was performed. As shown in FIG. 3, the user agrees with giving more weight to the opinion of a social network friend and they strongly agree with placing less value on the opinion of overly negative reviews. For example, characteristics with which the user agrees/strongly agrees with could receive positive weights (e.g., +2 for agree, +6 for strong agree), characteristics with which the user is neutral towards could receive a neutral weight (e.g., 0), and characteristics with which the user disagrees/strongly disagrees with could receive negative weights (e.g., −2 for disagree, −6 for strongly disagree). However, the invention is not limited to any particular weight or scale resolution. For example, the scales shown in FIG. 3 could be replaced with numerical scales that can have a range of values, and weights different from those described above may be used.

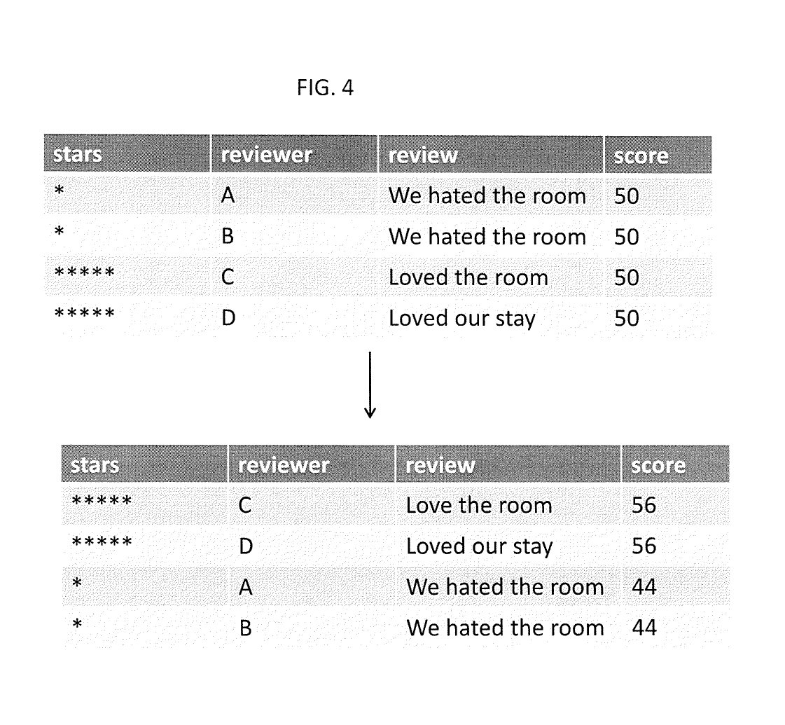

The method of FIG. 2 further includes the system reprocessing the reviews based on the weights to generate a ranking of the reviews (S206). As an example, all of the reviews generated by the initial search could initially have a same score (e.g., 50). The score of a given review can then be adjusted based on whether it includes a selected characteristic based on the corresponding weight. FIG. 4 illustrates reviews with their initial scores and their scores after the method has been applied. For example, initially 4 reviews are present where half of the reviewers give the hotel a very poor score and the other half of the reviewers give the hotel very high marks. Before the method is applied, since nothing is known about the credibility of each of the reviewers, they can each be given a same score. After the method is applied, it turns out that reviewers A and B are found to be overly negative (e.g., a characteristic not favored by the user) based on their other reviews and that reviewers C and D are social network friends of the user (e.g., a characteristic favored by the reviewer). Thus, the scores of the reviews by A and B are reduced and the scores of the reviews by C and D are increased, so that the reviews by C and D have a higher ranking.

The method may further include the server presenting to the user the most promising reviews. For example, the system may include a threshold, where reviews with scores below that threshold are not presented. In the example shown in FIG. 4, if the threshold is 50, then only the reviews by C and D would be visible to the user.

While the above has been described the offers with respect to offers for hotels and certain products, the invention is not limited to any particular offer. For example, the invention may be applied to bank/lender customer offers. For example, a user may be searching for financing for a car, home, vacation, etc., where the offers are from different banks/lenders, and the reviews indicate information about the banks/lenders (e.g., “granted loan quickly”, “required collateral”, etc.).

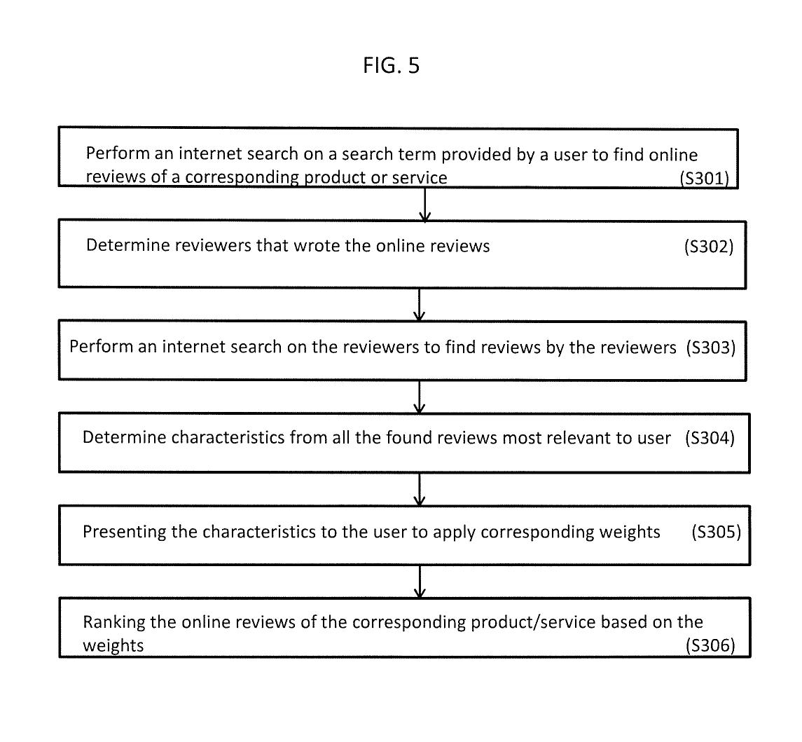

FIG. 5 illustrates a method of ranking online reviews according to an exemplary embodiment of the invention. The method includes: performing an internet search on a search term provided by a user to find online reviews (S301), determining reviewers that wrote the online reviews (S302), performing an internet search on the reviewers to find reviews by the reviewers for a corresponding product or service (S303), determining characteristics from all the found online reviews that are most relevant to the user (S304), presenting the determined characteristics to the user for applying weights to each characteristic (S305), and ranking the online reviews of the product or service based on the applied weights (S306).

The search term may include a product or service and the online reviews are for the product or service. The determining of the reviewers may be performed by extracting user names listed in the reviewers online reviews. The characteristics may be determined by determining unique text strings among the reviews, determining which of the text strings are uncommon, and generating the characteristics from the uncommon text strings. As an example, one of characteristics could indicate whether one of the reviewers uses a same social network as the user, or more particularly, how closely the one reviewer is to the user on the social network. As another example, one of the characteristics can indicate whether one of the reviewers is overly negative or positive in their reviews. The presenting may be performed by providing the user with a Likert scale for each characteristic. The ranking may be performed by giving each of the reviews of the product/service the user is interested an initial score and adjusting the score of each review based on whether that review includes one of the characteristics using the corresponding weight. The characteristic may be determined by extracting one or more preferences from a user profile of the user, performing an internet search for posts by the user, and determining the characteristics from the preferences and the posts. The characteristics may be determined from the posts by determining unique text strings among the posts, determining which of the text strings are uncommon, and generating the characteristics from the preferences and the uncommon text strings.

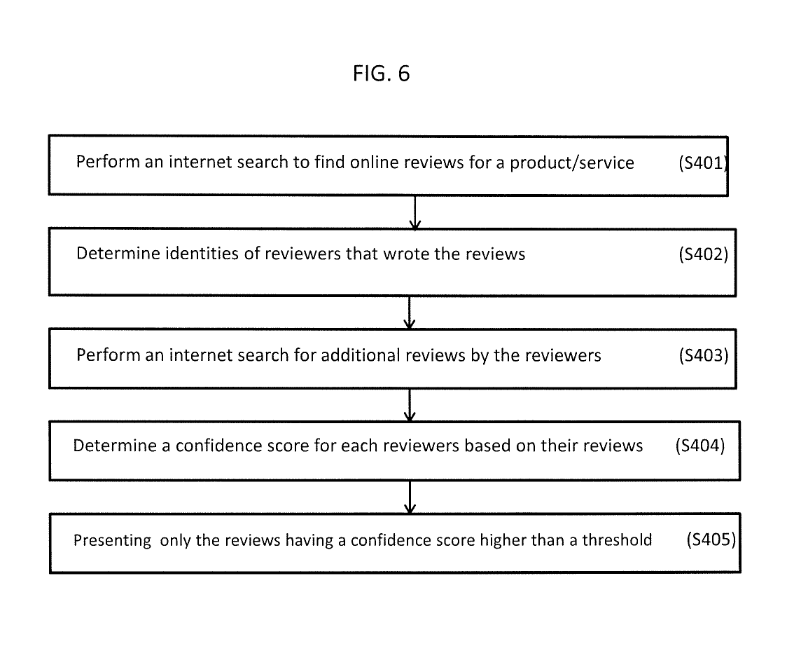

FIG. 6 illustrates a method of presenting online reviews according to an exemplary embodiment of the invention. The method included: performing an internet search to find online reviews for a given product or service (S401), determining identities of reviewers that wrote the reviews (S402), performing an internet search for additional reviews by the reviewers (S403), determining a confidence score of each reviewer based on their reviews (S404), and presenting only the reviews having a confidence score higher than a pre-defined threshold (S405).

The confidence score of a reviewer may be reduced if a majority of their reviews are negative, positive, or inconsistent. The confidence score of the reviewer may be increased if their reviews indicate they belong to a same social network as a user that initiated the search for the reviews.

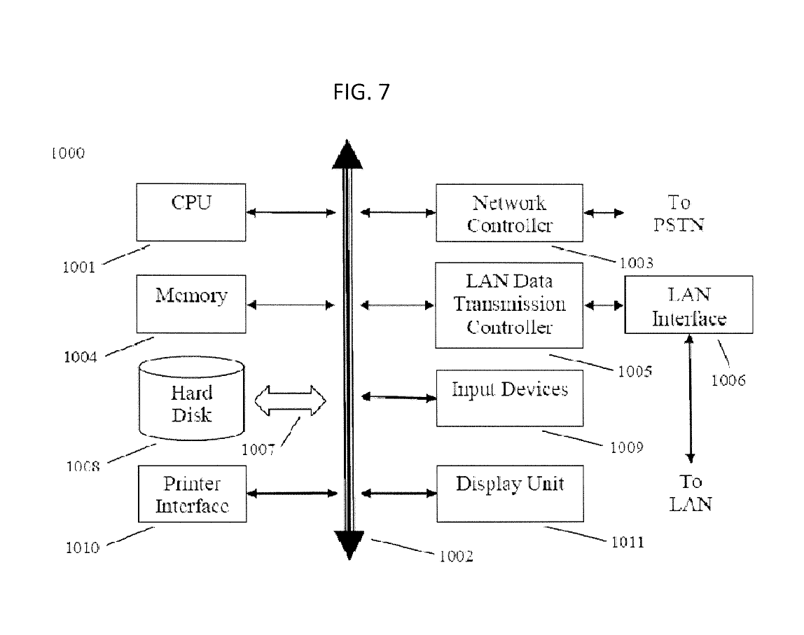

FIG. 7 illustrates an example of a computer system or the above-described server, which may execute any of the above-described methods, according to exemplary embodiments of the invention. For example, the methods of FIG. 2, FIG. 5, and FIG. 6 may be implemented in the form of a software application running on the computer system. Further, portions of the methods may be executed on one such computer system, while the other portions are executed on one or more other such computer systems. Examples of the computer system include a mainframe, personal computer (PC), a handheld computer, a server, etc. The software application may be stored on a computer readable media (such as hard disk drive memory 1008) locally accessible by the computer system and accessible via a hard wired or wireless connection to a satellite or a network, for example, a local area network, or the Internet, etc.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk 1008 (e.g., a digital video recorder), via a link 1007. CPU 1001 may be the computer processor that performs the above described methods.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for ranking online reviews, the method comprising:
performing an internet search on a search term provided by a user to find online reviews;
determining reviewers that wrote the online reviews related to the searched term;
performing an internet search on the reviewers to find other online reviews by the reviewers;
determining characteristics from all the found online reviews that are most relevant to the user;
presenting the determined characteristics to the user for applying weights to each characteristic; and
ranking the online reviews of the term searched by the user based on the applied weights.

2. The method of claim 1, wherein the search term includes a product or service and the online reviews are for the product or service.

3. The method of claim 1, wherein determining the reviewers comprises extracting user names listed in the reviewers online reviews.

4. The method of claim 1, wherein determining the characteristics comprises:
determining unique text strings among the reviews;
determining which of the text strings are uncommon; and
generating the characteristics from the uncommon text strings.

5. The method of claim 1, wherein one of characteristics indicates whether one of the reviewers uses a same social network as the user.

6. The method of claim 5, wherein the one characteristic indicates how closely the one reviewer is to the user on the social network.

7. The method of claim 1, wherein one of the characteristics indicates whether one of the reviewers is overly negative in their reviews.

8. The method of claim 1, wherein the one characteristic indicates whether one of the reviewers is overly positive in their reviews.

9. The method of claim 1, wherein the presenting includes providing the user with a Likert scale for each characteristic.

10. The method of claim 1, wherein the ranking comprises:
giving each of the reviews an initial score; and
adjusting the score of each review based on whether that review includes one of the characteristics using the corresponding weight.

11. The method of claim 1, wherein determining the characteristics comprises:
extracting one or more preferences from a user profile of the user;
performing an internet search for posts by the user; and
determining the characteristics from the preferences and the posts.

12. The method of claim 11, wherein determining the characteristics from the preference and posts comprises:
determining unique text strings among the posts;
determining which of the text strings are uncommon; and
generating the characteristics from the preferences and the uncommon text strings.

13. A server for ranking reviews, the server comprising:
a memory comprising a computer program; and
a processor configured to execute the program to perform an internet search on a search term provided by a user to find online reviews, determine reviewers that wrote the online reviews related to the searched term, perform an internet search for the reviewers to find other online reviews by the reviewers, determine characteristics from all the found online reviews that are most relevant to the user, present the determined characteristics to the user for applying weights to each characteristic, and rank the online reviews of the term searched by the user based on the applied weights.

14. The server of claim 13, wherein the server comprises a database configured to store a user profile for the user that indicates one or more preferences.

15. The server of claim 14, wherein a given one of the characteristics is relevant if it is similar to one of the preferences.

16. The server of claim 14, wherein the server is configured to send a form to the user to acquire the user profile when the user logs onto the server.

17. The server of claim 16, wherein the user profile indicates an identity of a social network and one of the characteristics indicates whether one of the reviewers is on the same social network.

18. The server of claim 13, wherein the characteristics are determined by determining unique text strings among the reviews, determining which of the text strings are uncommon, and generating the characteristics from the uncommon text strings.

19. The server of claim 13, wherein one of the characteristics indicates whether one of the reviewers is overly negative in their reviews.

20. The method of claim 13, wherein the one characteristic indicates whether one of the reviewers is overly positive in their reviews.

21. A method for presenting online reviews, the method comprising:
performing an internet search to find online reviews for a given product or service;
determining identities of reviewers that wrote the reviews;
performing an internet search for additional reviews by the reviewers;
determining a confidence score for each reviewer based on their reviews; and
presenting only the reviews having a confidence score higher than a pre-defined threshold.

22. The method of claim 21, wherein the confidence score of the reviewer is reduced if a majority of their reviews are negative.

23. The method of claim 21, wherein the confidence score of the reviewer is reduced if a majority of their reviews are positive.

24. The method of claim 21, wherein the confidence score of the reviewer is reduced if a majority of their reviews are inconsistent with one another.

25. The method of claim 21, wherein the confidence score of the reviewer is increased if their reviews indicate they belong to a same social network as a user that initiated the search for the reviews.
